(19) United States
(12) Patent Application Publication
(10) Pub. No.: US 2019/0247928 A1
(43) Pub. Date: Aug. 15, 2019

(54) COPPER AND TIN BASED PCD CUTTING ELEMENT AND METHOD OF MAKING

(71) Applicant: DIAMOND INNOVATIONS, INC., Worthington, OH (US)

(72) Inventors: Hui ZHANG, Westerville, OH (US); Abds-Sami MALIK, Westerville, OH (US)

(73) Assignee: DIAMOND INNOVATIONS, INC., Worthington, OH (US)

(21) Appl. No.: 16/273,266

(22) Filed: Feb. 12, 2019

Related U.S. Application Data
(60) Provisional application No. 62/629,819, filed on Feb. 13, 2018.

(51) Int. Cl. B23B 27/14; C04B 35/528; C04B 35/645; C04B 35/63

(52) U.S. Cl. CPC B23B 27/14; C04B 35/528; C04B 35/645; C04B 35/6303; B23B 2226/315; C04B 2235/5436; C04B 2235/407; B23B 2224/00; C04B 2235/427

(57) ABSTRACT

Diamond particles with enhanced reactivity are used to sinter polycrystalline diamond (PCD), under high pressure and high temperature conditions. Copper and tin form a solution with transition metal catalyst (cobalt) used to sinter diamond particles. Copper and tin enhance the reactivity of the diamond particles, reduce the coefficient of thermal expansion (CTE) mismatch between cobalt and polycrystalline diamond, and lead to a more homogeneous distribution of catalyst metal in PCD. A cutting element may comprise a substrate and a polycrystalline diamond table bonded to the substrate produced by sintering diamond particles with enhanced reactivity mixed with standard diamond particles and chemical additives. These combined effects (more reactive diamond particles, reduced CTE mismatch, and homogeneous distribution of catalyst metal) lead to better performing tools.

### TECHNICAL FIELD AND INDUSTRIAL APPLICABILITY

The present disclosure relates to sintering of polycrystalline diamond (PCD) materials, which are able to withstand the high temperatures associated with cutting, drilling, and mining applications. The diamond particles, on the order of 1 to 50 μm diameter, are treated to impart greater reactivity for diamond formation, leading to PCD that is more thermally stable.

Conventionally, PCD is formed by sintering diamond particles under high pressure and high temperature (HPHT) in the presence of a transition metal catalyst, typically cobalt. HPHT conditions for PCD sintering include pressures at or above 55 kBar and temperatures at or above 1400° C. At those conditions, the transition metal dissolves carbon from the diamond and re-precipitates it as diamond, forming inter-particle diamond bonds to make a sintered diamond compact. After sintering, the transition metal catalyst remains in the diamond compact, and can reduce its thermal stability during use. This is because differences in the coefficient of thermal expansion (CTE) between the diamond and the metal catalysts become apparent due to the frictional heat generated during use. The CTE mis-match induces micro-cracks in the diamond compact, leading to faster erosion. Also, at the elevated temperatures encountered during use, the metal catalyst may promote the back-conversion of diamond to graphite or amorphous carbon, leading to more modes of failure.

In order to overcome these problems, it would be desirable to sinter PCD with very little or no transition metal catalysts. By using diamond particles that are more reactive and catalyst systems that are more effective, a more thermally stable and higher performing PCD can be made.

### SUMMARY

In one embodiment, a cutting element for a tool may comprise a substrate; a polycrystalline diamond table bonded to the substrate which is produced by sintering diamond particles with enhanced reactivity.

In another exemplary embodiment, a cutting element for a tool may comprise a substrate; a polycrystalline diamond table bonded to the substrate which is produced by sintering diamond particles with enhanced reactivity mixed with standard diamond particles.

In a third exemplary embodiment, a cutting element for a tool may comprise a substrate; a polycrystalline diamond table bonded to the substrate which is produced by sintering diamond particles with enhanced reactivity mixed with standard diamond particles and other chemical additives.

### BRIEF DESCRIPTION OF THE DRAWINGS

The following detailed description can be read in connection with the accompanying drawings in which like numerals designate like elements:

FIG. 1 is a representation showing graphene in the interstices between diamond particles.

FIG. 2 is a representation showing graphene in between two diamond particles.

FIG. 3 is a cross-sectional view of a mixture of graphene treated diamond with standard diamond particles, and tungsten carbide substrate in the tantalum cup.

FIG. 4 is a schematic perspective view of a polycrystalline diamond cutter according to an exemplary embodiment.

FIG. 5 is the SEM image on top surface of PCD, which was sintered from graphene treated diamond.

FIG. 6 is the SEM image on cross-section of PCD, which was produced from graphene treated diamond.

FIG. 7 is the SEM image on top surface of PCD, which was made from standard diamond (non-graphene).

FIG. 8 is the SEM image on cross-section of PCD, which was made from standard diamond (non-graphene).

FIG. 9 is the SEM image on top surface of PCD, which was sintered from graphene treated diamond with Pb additives.

FIG. 10 is the SEM image on cross-section of PCD, which was produced from graphene treated diamond with Pb additives.

FIG. 11 is the XRD pattern of PCD that was sintered from graphene treated diamond.

FIG. 12 is a plot of the wear volume of the finished PCD vs. the volume of rock removed.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, about 50% means in the range of 45% to 55%. When the term, “substantially free”, is used referring to catalyst in interstices, interstitial matrix, or in a volume of polycrystalline element body, such as polycrystalline diamond, it should be understood that many, if not all, of the surfaces of the adjacent diamond crystals may still have a coating of the catalyst. Likewise, when the term “substantially free” is used referring to catalyst on the surfaces of the diamond crystals, there may still be catalyst present in the adjacent interstices.

As used herein, the term “graphene” refers to a form of carbon, in which the carbon atoms are arranged in a 2-dimensional hexagonal lattice, that can be as thin as one atomic layer (<1 nm). In a more specific embodiment, the single-layer graphene may each have a thickness of 0.35 to 1.7 nm. These layers can also exist as double or multiple stacked sheets.

As used herein, the term ‘graphene treated diamond’ refers to diamond particles in atomic-level contact with single layer, bi-layer, or multi-layer graphene.

As used herein, the term “graphane” refers to a form of hydrocarbon, in which the carbon atoms are arranged in a 2-dimensional hexagonal lattice, as thin as one atomic layer, in which at least some of the carbon atoms have hydrogen atoms bonded to them and which gives rise to a characteristic Raman spectrum exhibiting peaks at 1330 cm⁻¹ (labeled ‘D’), 1580 cm⁻¹ (labeled ‘G’), 2700 cm⁻¹ (labeled ‘2D’) and 2950 cm⁻¹ (corresponding to the C—H bond) and in which the D/G peak intensity ratio is >0.5. Graphane can also be described as graphene that has been fully or partially hydrogenated.

As used herein, the term ‘graphane treated diamond’ refers to diamond particles in atomic-level contact with graphane.

The sintered PCD cutters, representing a polycrystalline diamond bonded to a tungsten carbide substrate, were fabricated using the HPHT process. After fabrication all PCD cutters were shaped by grinding and polishing to a cylindrical shape.

Raman spectroscopy (Nakamoto, K., Infrared and Raman spectra of inorganic and coordination compounds. 5th ed., 1997, New York: John Wiley and Sons, Inc.) is used to characterize graphene, graphane, graphite, and diamond.

Scanning electron microscopy (SEM) and elemental analysis (EDS) were performed on a JSM-7200F SEM with 5 to 15 kV accelerating voltage. EDS was done with an Oxford XMAX with solid state detector.

TABLE 1
Calculated driving force of diamond formation

| Pressure | Temperature (° C.) | Driving force (J/mol) |
|---|---|---|
| 75 | 1400 | 3761.1 |
| 75 | 1600 | 2971.6 |
| 75 | 1800 | 2181.6 |
| 75 | 2000 | 1388.0 |
| 65 | 1200 | 3022.5 |
| 65 | 1300 | 2618.6 |
| 65 | 1400 | 2214.0 |
| 65 | 1600 | 1403.5 |
| 55 | 1000 | 2286.2 |
| 45 | 700 | 1960.7 |

Diamond can be directly converted from graphite, under high pressure and high temperature conditions. The underlying mechanism at the atomic level may be correlated to the p-electrons on carbon atoms of graphite, which may attract every other carbon atom in graphite to cause the carbon ring to pucker, thus forming a diamond material, as sp³ bonded carbon, from sp² bonded carbon. To evaluate the effect of temperature and pressure, the thermodynamic driving force of diamond formation was calculated (Table 1) at pressure from 45 to 75 kbar with temperature ranges from 700° C. to 2000° C. A positive driving force indicates that graphite to diamond conversion is favorable from a thermodynamic point of view; and a higher number indicates the graphite to diamond conversion is more likely to occur. But the kinetics of this reaction is generally too slow for industrial processes, thus the need for metal catalysts, such as cobalt, in conventional methods.

Other metal catalysts, copper (Cu) and tin (Sn), have been investigated for diamond synthesis. At this temperature range (1400° C. to 1800° C.), previous studies suggested that extremely long sintering time is required to make these two catalysts functional (about 2 to 20 hours). For example, using Cu as a catalyst, the sintering time is at least 5 h for the experiments conducted between 1400° C. to 1700° C. [S. K. Singhal et al., Temperature dependence of growth of diamond from Cu—C system under high pressure. Journal of Crystal Growth 154 (1995) 297-302]. When temperature increased to 1800° C., sintering time can be slightly shortened but still need 4 h [I. N. Kupriyanov et al., HPHT growth and characterization of diamond from a copper-carbon system, Diamond & Related Materials 69 (2016) 198-206]. Similar for Sn, the sintering time (20 h) is even longer than Cu in the 1600° C. condition [Y. N. Palyanov et al., Diamond crystallization from a tin-carbon system at HPHT conditions, Diamond & Related Materials 58 (2015) 40-45]. And at 1700° C. and 1800° C., the sintering time can be reduced to 2 h but still considered as sluggish process. Overall in the temperature range 1400° C.-1800° C., none of these long reaction time processes can be considered as practical for industrial applications.

However, the low catalytic activity can alternatively be solved by starting with a material that is more reactive, thereby eliminating, or substantially reducing, the need for a cobalt metal catalyst. Non-diamond and non-graphite carbon that may be more reactive include, but are not limited to, graphene, graphane, carbon nanotubes, and buckyballs. Such nano-scale materials would be expected to be more reactive (i.e. thermodynamically unstable) sources of carbon that can convert to diamond under the appropriate temperature and pressure conditions. In particular, graphene or graphane, subjected to HPHT, in the presence of diamond particles, could be expected to convert to diamond and thus form a sintered solid PCD compact.

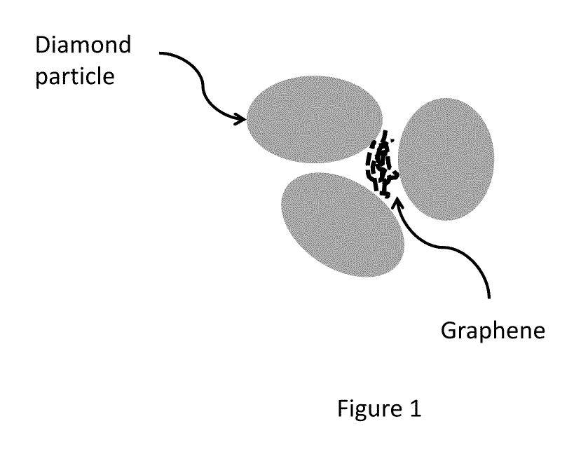

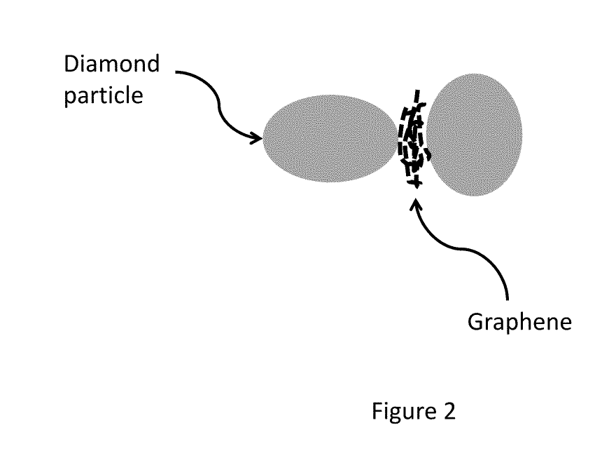

The location of the graphene or graphane in relation to the diamond particles is critical for the PCD compact to form, as shown in FIG. 1-FIG. 2. In the scenario demonstrated in FIG. 1, there may be little to no graphene (or graphane) to diamond conversion, thus no PCD formation, since the graphene or graphane is in an interstitial pocket between diamond particles. It is readily apparent that the graphene or graphane in this case would not be subjected to the pressures required to form diamond. However, as shown in FIG. 2, if the graphene or graphane is present directly between two diamond particles, it may convert to diamond to bond the two diamond particles together because the graphene or graphane could be subjected to the pressures required for diamond formation. Multiplying the latter scenario many times, it would be possible to produce PCD compacts.

Conventional mixing techniques, however, are not designed to both mix two dissimilar components (e.g. graphene and diamond) and also ensure the precise placement of one component relative to another. Therefore, non-conventional methods must be employed.

By non-conventional means, the graphene or graphane can be placed advantageously to allow for diamond to diamond sintering to take place. Rather than conventionally mixing graphene or graphane with diamond particles, the diamond particles are graphene treated or graphane treated.

There exist additional functionalities of Cu and Sn other than catalyst, when the temperature is consistently lower than 1800° C. At this temperature, Cu and Sn additives may facilitate the treatment of diamond particles with graphene or graphane. Also, the Cu and Sn can form a solution with a catalytic metal, such as Co, to reduce the CTE mismatch between the Co and diamond. This would promote the thermal stability and increase the performance of PCD. Another effect is that Cu and Sn may effectively prevent the segregation and improve the homogeneous distribution of metal in the PCD layer. All of these effects in combination may lead to an improved sintering process and product performance.

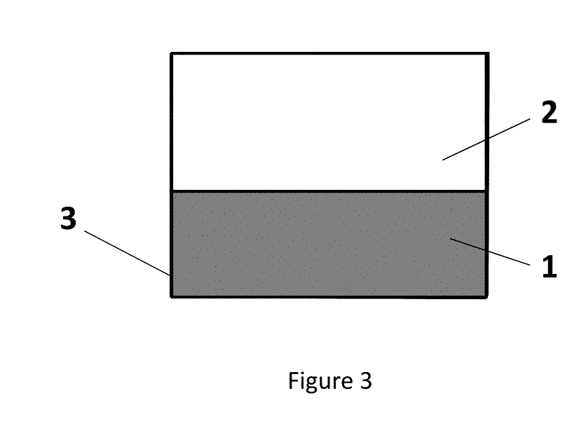

Exemplary embodiments disclose a cutting element for a tool and a method of making the cutting element. One process for making PCD cutting elements involves the mixing of various sized graphene or graphane treated diamond with (or without) standard diamond particles 1, loading into a tantalum cup 3 and placing a substrate 2 in the cup, as shown in FIG. 3. This assembly is then loaded into a HPHT cell and pressed at 45 kbar to 80 kbar and temperature ranges from 700° C. to 1800° C.

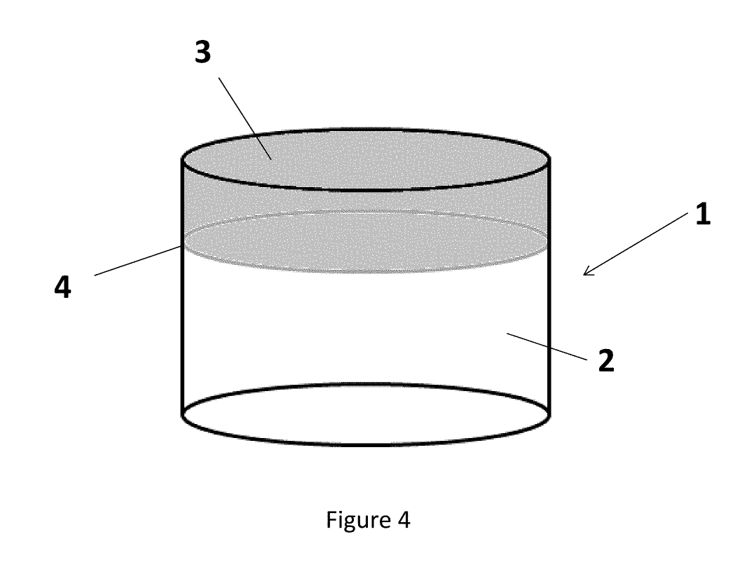

In an exemplary embodiment (FIG. 4), a schematic perspective view of a cylindrical shape PCD cutter 1 is produced in a high pressure high temperature (HPHT) process.

The PCD cutter 1 comprises a substrate 2, which is made of hard metal, alloy, or composite, such as cemented carbide or cobalt sintered tungsten carbide (WC—Co). PCD cutter blank can be later machined to a desired shape and dimensions. The recovered polycrystalline diamond table may be attached or joined coherently to the substrate along the interface 4.

Exemplary embodiments are provided for the detailed process as described above.

### Embodiment 1

2.0 g of graphene treated diamond (particle size 0.6 μm to 100 μm) was loaded into a 16 mm diameter Ta cup, followed by the placement of tungsten carbide substrate. This assembly was built into a high pressure cell and pressed at 45 kbar to 80 kbar and 700° C. to 1800° C. for up to 30 minutes, then brought back to atmospheric pressure and recovered from the high pressure cell.

### Embodiment 2

2.0 g graphene treated diamond (particle size 0.6 μm to 100 μm) was mixed with 0.15 g fine diamond feed (particle size 0.6 μm to 1.8 μm) and 0.02 g chemical additives (e.g. Pb). This obtained mixture was loaded into a Ta cup, and then a tungsten carbide substrate was placed. The assembly was built into a high pressure cells and pressed at 45 kbar to 80 kbar and 700° C. to 1800° C. for up to 1 hour.

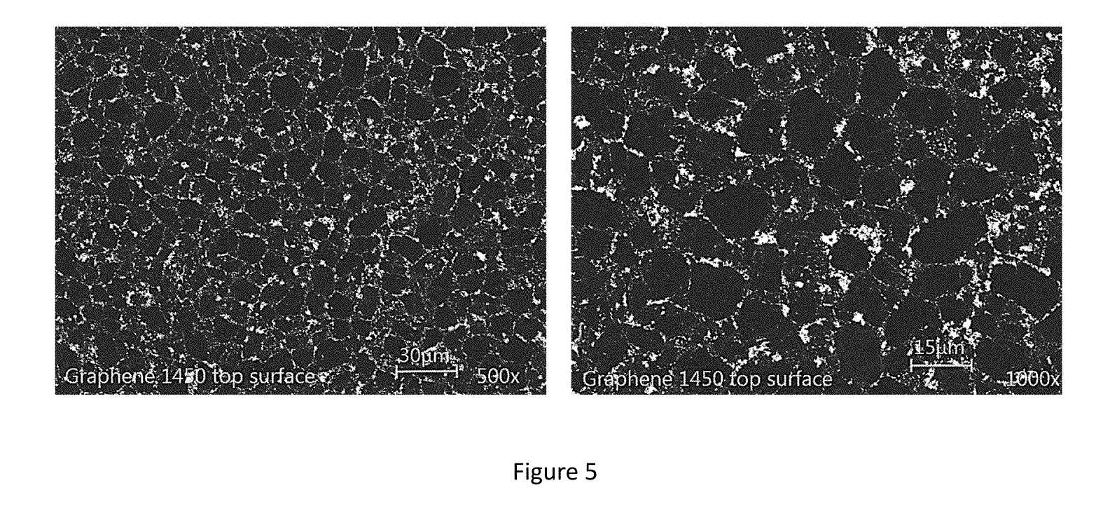

The PCD samples sintered from graphene treated diamond particles were characterized by SEM and the results are presented in FIG. 5, at 500× (left image) and 1000× (right image) magnification, respectively. In both images, the lighter areas are metal while the dark areas are diamond which is exhibited as a continuous mass, indicating the formation of diamond-diamond bonding between individual diamond particles. It is apparent that the sample is uniform and homogeneous.

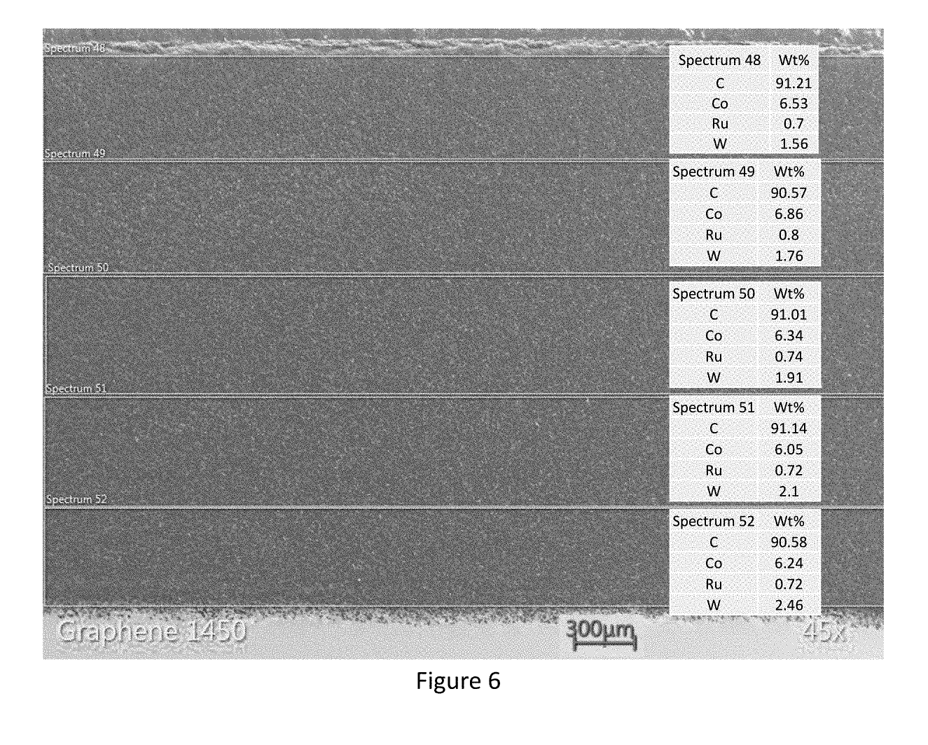

The uniformity of the sample can be further appreciated by the distribution of diamond, Co, W and Ru in the elemental analysis of the cross-section. FIG. 6 shows the EDS element analysis across the cross-section of the sintered diamond. Proceeding from the tungsten carbide interface at the bottom, five consecutive cross section layers exhibit a consistent weight fraction of these elements. Carbon is detected at 90.5 to 91.2 wt % in each layer, cobalt is detected at 6.0 to 6.9 wt. %, ruthenium is measured at 0.70 to 0.75 wt. % and tungsten is measured at between 1.5 to 2.5 wt. % in each layer; indicating that diamond and metal are uniformly distributed over the entire PCD layer.

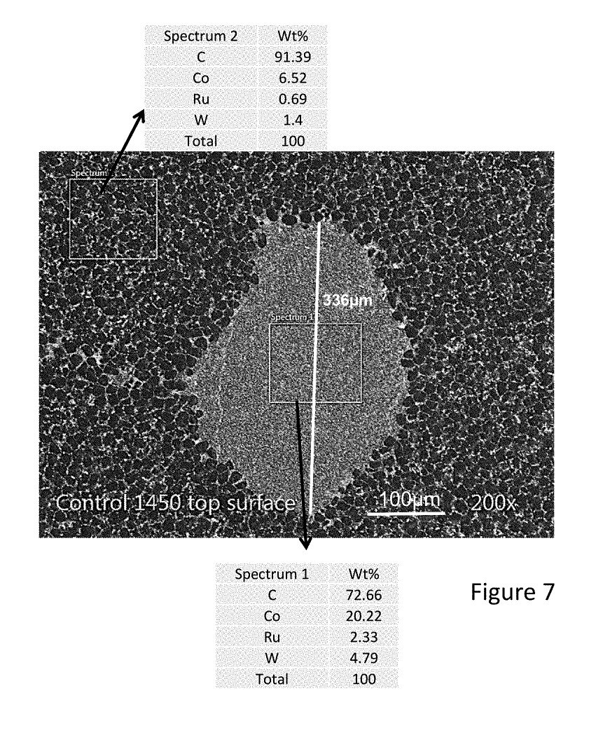

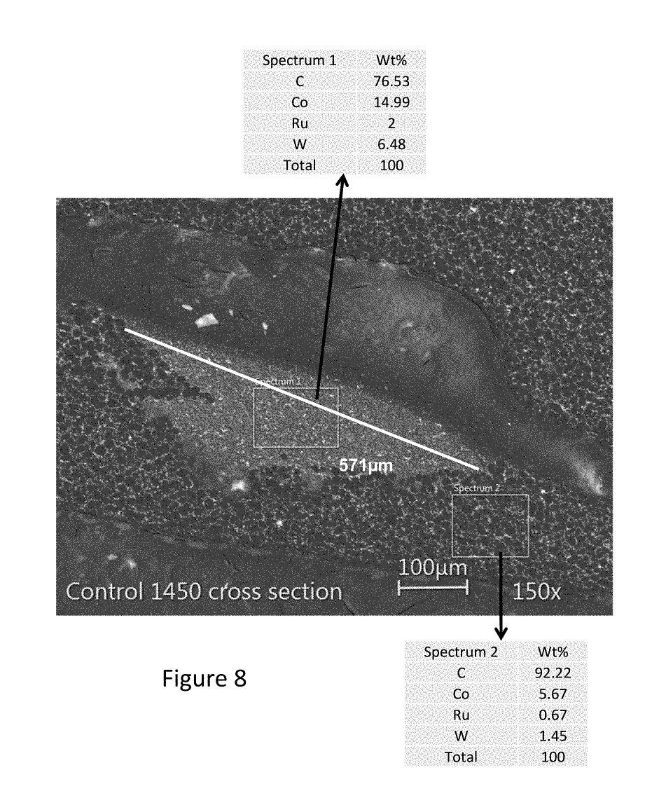

In contrast, PCD made from standard diamond (the control sample) exhibited a non-uniform distribution. A representative result is shown in FIG. 7 (200× magnification), which exhibits a 300 μm×200 μm pool of metal rich area near the top surface of the PCD. EDS analysis shows a much higher Co concentration in this area, indicating a very inhomogeneous distribution of metal and diamond in the polycrystalline diamond. This is in stark contrast to FIG. 5. The cross-section SEM of the sample shows a 570 μm×200 μm pool (FIG. 8) and its morphology is similar to the one found in the previous top surface SEM. EDS analysis of the pool area also shows a much higher Co concentration than the surrounding area, indicating the pool is also metal rich. Comparing FIGS. 5, 6 with 7 and 8, it can be concluded that PCD samples sintered from graphene or graphane treated diamond, and with copper and tin, is more uniform and homogeneous.

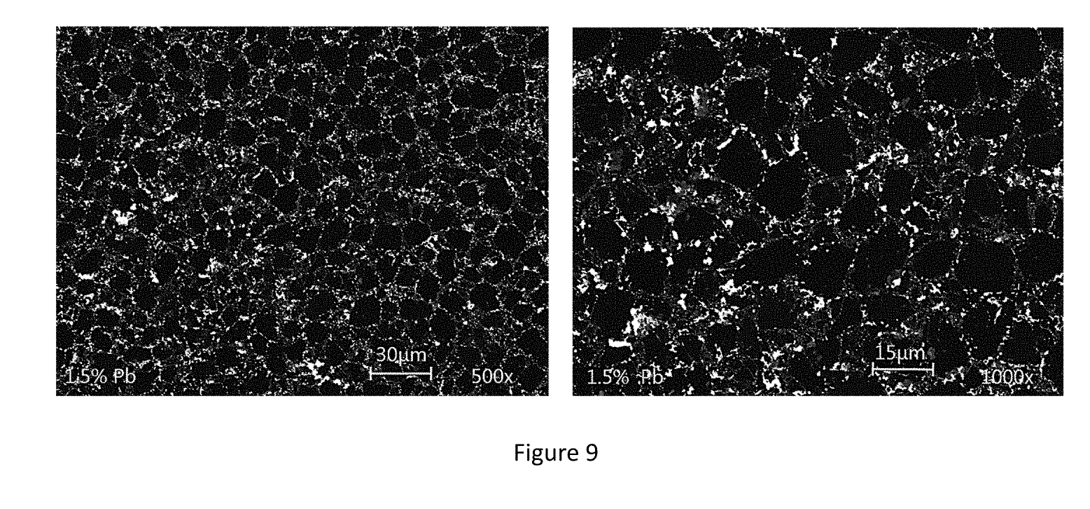

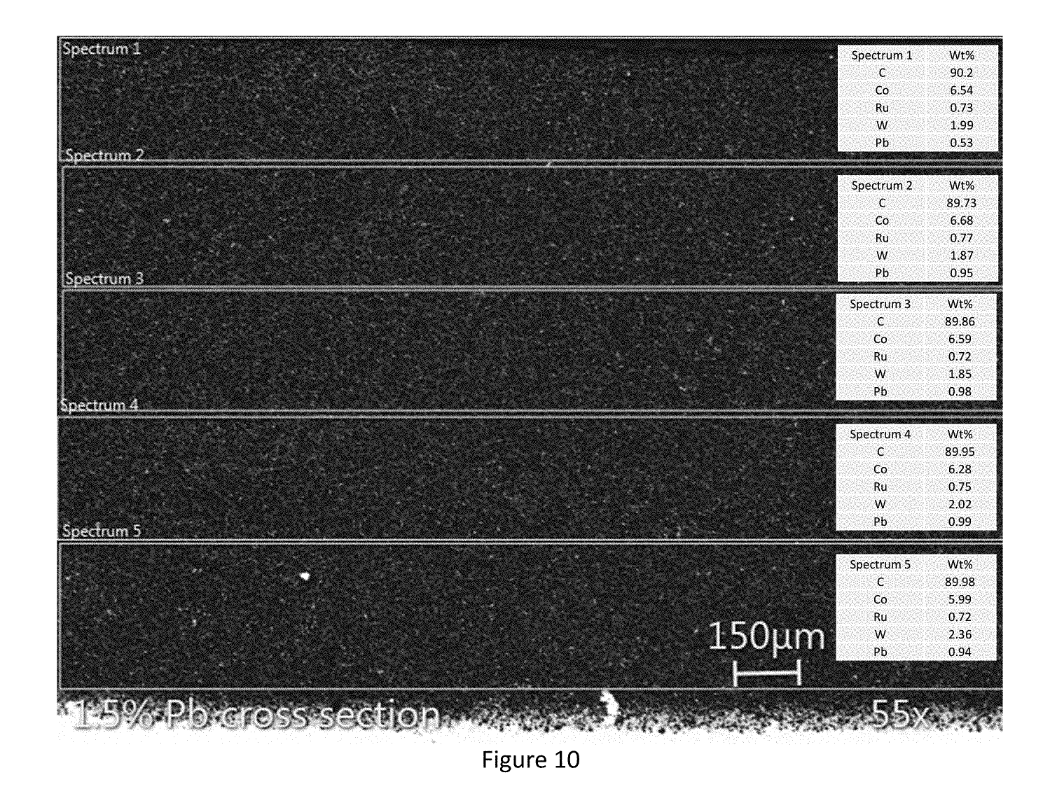

FIG. 9 shows SEM images of PCD made from graphene treated diamond with Pb additives, at 500× and 1000× magnification, respectively. The morphology is similar to PCD samples sintered from graphene treated diamond (FIG. 5). The formation of diamond-diamond bonding can clearly be seen, as well as the uniformly distributed metal and diamond particle boundaries, without pools detected. The EDS analysis along the cross section (FIG. 10) is also similar to FIG. 6. Carbon is detected at 89.7 to 90.2 wt. % in each layer, cobalt is detected at 5.9 to 6.7 wt. %, ruthenium is measured at 0.72 to 0.77 wt. %, tungsten is measured at between 1.8 to 2.4 wt. % in each layer and Pb is measured at 0.5-1.0 wt. %; indicating that diamond and metal are uniformly distributed over the entire PCD layer.

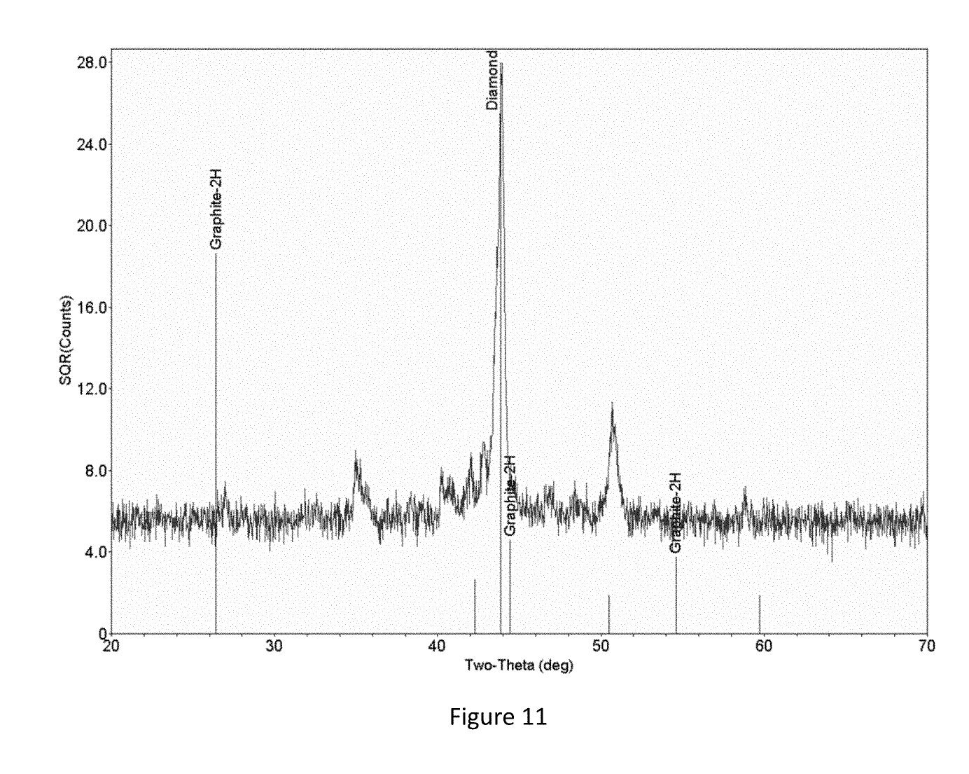

FIG. 11 shows a representative X-ray diffraction (XRD) pattern of PCD sintered from graphene treated diamond. Only peaks corresponding to diamond and Co are detected. Elemental analysis was also performed, and the results for nineteen sets of matching samples are listed in Table 2. ‘Gra.’ Indicates PCD made from graphene treated diamond particles, compared with PCD made from standard diamond particles, as labeled in ‘Con.’ The two samples in each set were sintered in the same cell and same HPHT condition. For PCD made from graphene treated diamond, Co is detected at levels ranges from 0 to 7.3 wt % and Cu, Sn, Ru and Pb are detected at levels ranging from 0.02 to 1.13 wt %. While the matching PCD made from standard diamond particles, have a slightly higher Co concentration up to 7.7 wt %. Ru and Pb are observed at levels around 0.05 to 1.42 wt %.

TABLE 2

| | | Co, | Cu, | Sn, | Ru, | Pb, |
|---|---|---|---|---|---|---|
| Samples | | % wt. | % wt. | % wt. | % wt. | % wt |
| 1 | Gra. | 0.024 | 0.076 | 0 | 0.054 | 0 |
| | Con. | 0.038 | 0 | 0 | 0.059 | 0 |
| 2 | Gra. | 6.96 | 0.085 | 0.024 | 0.658 | 0 |
| | Con. | 7.04 | 0 | 0 | 0.669 | 0 |
| 3 | Gra. | 7.04 | 0.086 | 0.023 | 0.653 | 0 |
| | Con. | 6.94 | 0 | 0 | 0.652 | 0 |
| 4 | Gra. | 7.08 | 0.105 | 0.035 | 0.648 | 0 |
| | Con. | 7.00 | 0 | 0 | 0.710 | 0 |
| 5 | Gra. | 6.76 | 0.096 | 0.026 | 0.626 | 0 |
| | Con. | 7.00 | 0 | 0 | 0.634 | 0 |
| 6 | Gra. | 6.81 | 0.093 | 0.033 | 0.666 | 0 |
| | Con. | 6.82 | 0 | 0 | 0.649 | 0 |
| 7 | Gra. | 6.89 | 0.091 | 0.026 | 0.616 | 0 |
| | Con. | 6.91 | 0 | 0 | 0.622 | 0 |
| 8 | Gra. | 7.09 | 0.097 | 0.033 | 0.637 | 0 |
| | Con. | 7.18 | 0 | 0 | 0.708 | 0 |
| 9 | Gra. | 5.24 | 0.126 | 0.051 | 0.520 | 0 |
| | Con. | 7.05 | 0 | 0 | 0.710 | 0 |
| 10 | Gra. | 6.93 | 0.104 | 0.037 | 0.610 | 0 |
| | Con. | 7.10 | 0 | 0 | 0.650 | 0 |
| 11 | Gra. | 7.02 | 0.16 | 0.061 | 0.610 | 0 |
| | Con. | 6.90 | 0 | 0 | 0.620 | 0 |
| 12 | Gra. | 6.86 | 0.086 | 0.037 | 0.590 | 0.371 |
| | Con. | 7.65 | 0 | 0 | 0.659 | 0.275 |
| 13 | Gra. | 6.33 | 0.072 | 0.038 | 0.563 | 0.656 |
| | Con. | 7.06 | 0 | 0 | 0.656 | 0.536 |
| 14 | Gra. | 6.48 | 0.062 | 0.039 | 0.598 | 0.688 |
| | Con. | 5.90 | 0 | 0 | 0.577 | 1.170 |
| 15 | Gra. | 6.14 | 0.059 | 0.019 | 0.587 | 1.130 |
| | Con. | 6.04 | 0 | 0 | 0.598 | 1.260 |
| 16 | Gra. | 7.25 | 0.093 | 0.055 | 0.648 | 0.422 |
| | Con. | 7.48 | 0 | 0 | 0.687 | 0.527 |
| 17 | Gra. | 6.48 | 0.076 | 0.040 | 0.627 | 0.781 |
| | Con. | 6.80 | 0 | 0 | 0.641 | 0.586 |
| 18 | Gra. | 6.30 | 0.073 | 0.031 | 0.606 | 0.750 |
| | Con. | 6.66 | 0 | 0 | 0.666 | 1.250 |
| 19 | Gra. | 6.55 | 0.056 | 0.025 | 0.586 | 0.855 |
| | Con. | 5.77 | 0 | 0 | 0.630 | 1.42 |

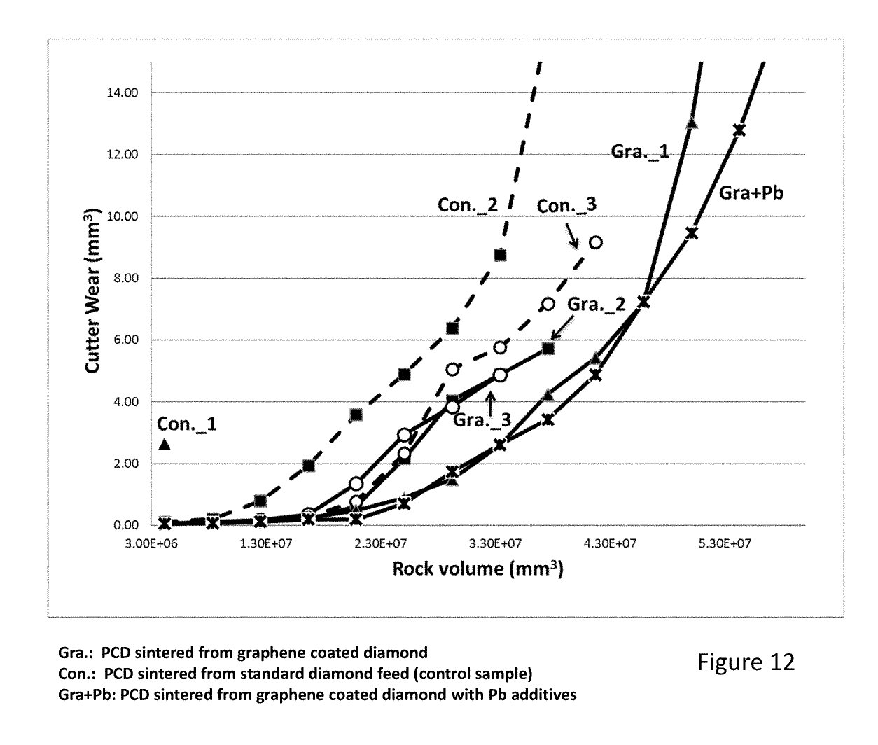

The mechanical performance of the PCD cutter is typically characterized by abrasion resistance tests, by cutting granite on a standard vertical turret lathe. FIG. 12 shows the results of abrasion resistance testing of PCD made from graphene treated diamond particles, along with PCD made from standard diamond particles. The performance is represented by the cutter wear (y-axis) as a function of the amount of granite removed (x-axis). At any given rock volume, a smaller amount of cutter wear indicates better cutter performance. Or alternatively, a higher amount of removed granite under same cutter wear suggests a longer expected tool life. The tools made from graphene treated diamond are labeled Gra._1, Gra._2, and Gra._3. The corresponding tools made from standard diamond (the control samples) are labeled as Con._1, Con._2, and Con._3. HPHT sintering of these PCD cutters were identical. Thus sample Gra._1 and Con._1 were sintered in the same HPHT cell and so were subjected to the same sintering conditions. The same is true for the other sample sets. Gra+Pb represents the PCD sintered from graphene treated diamond with Pb additives.

As the plots clearly show, the wear behavior of most PCD samples were similar at early stages, except for sample Con._1. This sample failed early in the test and only one data point was collected. The matching sample, Gra._1 however, performed very well, with 5.0×10⁷ mm³ rock volume per 13.05 mm³ of cutter wear. Similarly, comparing sample Gra._2 to Con._2, it can be seen that Gra._2 shows significantly better performance. For example, after removing the same amount of 3.75×10⁷ mm³ rock, the cutter wear of Gra._2 is 5.7 mm³, about 70% less than the 16.2 mm³ of Con._2. The performance of Gra._3 and Con._3 are more closely matched, especially in the early stages of the test, but Gra._3 provides better performance overall. When removing 3.34×10⁷ mm³ rock volume, the cutter wear of Gra._3 is 4.9 mm³ while it is 5.8 mm³ for Con._3. The performance of Gra+Pb is comparable to Gra._1, with 5.43×10⁷ mm³ rock volume per 12.8 mm³ of cutter wear. These measurable performance improvements suggest an improvement in thermal stability of cutters sintered from graphene treated diamond particles.

What is claimed is:

1. A polycrystalline diamond compact, comprising:
diamond particles bonded to each other; and
a cemented tungsten carbide substrate bonded to the polycrystalline diamond compact,
wherein the polycrystalline diamond compact is comprised of at least one of copper and tin.

2. A polycrystalline diamond compact of claim 1, comprising at least one of copper at 0.05 to 0.2 wt. % and tin at 0.01 to 0.07 wt. %.

3. The polycrystalline diamond compact of claim 1, further comprising at least one of cobalt, ruthenium and lead.

4. The polycrystalline diamond compact of claim 2, wherein cobalt is uniformly distributed throughout the polycrystalline diamond compact.

5. The polycrystalline diamond compact of claim 1, wherein the diamond particles are graphene treated.

6. The polycrystalline diamond compact of claim 1, comprising carbon at 90.5 to 91.2 wt %, cobalt at 6.0 to 6.9 wt %, ruthenium at 0.70 to 0.75 wt % and tungsten at 1.5 wt % to 2.5 wt

7. A polycrystalline diamond compact, comprising:
diamond particles bonded to each other with cobalt, tungsten, and ruthenium distributed uniformly through the polycrystalline diamond compact.

8. The polycrystalline diamond compact of claim 7, wherein the cobalt, tungsten, ruthenium, and lead are distributed uniformly through the polycrystalline diamond compact.

9. The polycrystalline diamond compact of claim 7, wherein the compact comprises carbon at 90.5 to 91.2 wt. %, cobalt at 6.0 to 6.9 wt. %, ruthenium at 0.70 to 0.75 wt. % and tungsten at 1.5 wt. % to 2.5 wt. %.

10. The polycrystalline diamond compact of claim 8, wherein the compact comprises carbon at 89.7 to 90.2 wt. %, cobalt at 5.9 to 6.7 wt. %, ruthenium at 0.72 to 0.77 wt. %, tungsten between 1.8 wt. % to 2.4 wt. %, and lead at 0.5 to 1.0 wt. %.

11. The polycrystalline diamond compact of claim 7, wherein the graphene treated diamond particles have an average diameter of between 0.6 μm and 100 μm.

12. A method of making a polycrystalline diamond compact comprising:
loading graphene treated diamond particles into a HPHT cell;
pressing the HPHT cell at from about 45 kBar to about 80 kBar; and
bringing the cell back to atmospheric pressure and temperature.

13. The method of claim 12, wherein the graphene treated diamond particles is combined with diamond particles.

14. The method of claim 12, wherein the graphene treated diamond particles is combined with diamond particles and chemical additives.

15. The method of claim 12, wherein the temperature is up to about 1800° C.

16. The method of claim 12, wherein the temperature is in a range between about 700° C. and about 1800° C.

17. The method of claim 12, wherein time at HPHT is 10 minutes to 60 minutes.

18. The method of claim 12, wherein the chemical additive is a least one of copper, tin, lead and ruthenium.

19. The polycrystalline diamond compact of claim 1, wherein the diamond particles are graphane treated.

20. The polycrystalline diamond compact of claim 7, wherein the diamond particles are graphane treated and have an average diameter of between 0.6 μm and 100 μm.
